(19) United States
(12) Patent Application Publication
(10) Pub. No.: US 2007/0206372 A1
(43) Pub. Date: Sep. 6, 2007

(54) Illuminated container

(76) Inventor: Robert J. Casillas, Tucson, AZ (US)

Correspondence Address: QUARLES & BRADY LLP, ONE SOUTH CHURCH AVENUE, SUITE 1700, TUCSON, AZ, 85701-1621, US

(21) Appl. No.: 11/366,180

(22) Filed: Mar. 2, 2006

(51) Int. Cl. F21V 33/00

(52) U.S. Cl. 362/101; 362/154

(57) ABSTRACT

A container having a convex recess extending into the interior of the container and an illumination source disposed within the convex recess. A bottle containing a drinkable liquid and having a convex recess also has an illumination source disposed within the convex recess for the purpose of emitting light for aesthetic, marketing, or other reasons.

### BACKGROUND OF THE INVENTION

1. Field of the Invention

This invention relates generally to novelty products and more particularly to apparatus that include a container with a light source disposed therein for illuminating the container and its contents.

2. Description of the Related Art

Products including a container with a liquid and a light source are common novelty items. For example, LAVA-brand lamps house a liquid and globular matter that is immiscible in the liquid (such as oil in water) over a light source. The illumination effects on the globular matter and the shadows created outside of the container provide for relaxation, amusement, and entertainment.

Consumer beverage and other industries have long been interested in marketing and point-of-dispensing displays that illuminate bottles and other containers in creative or interesting ways to attract consumer attention. Thus, so-called “back bar bottle glorifiers” offered by Centsible Lighting LLC provide bases harboring light sources such that, when a bottle is placed upon the base and the light source activated, the bottle is attractively illuminated from the bottom.

While this apparatus may be suitable for its intended purpose, it is limited by the fact that the bottle or container is only illuminated when on the base. Moreover, providing such a base for every bottle (including individual serving bottles) can be cumbersome to display and relatively expensive.

Inserts that illuminate and are placed inside a container or bottle are also known. An obvious drawback of such inserts, however, is that they must be made of inert and non-toxic ingredients or deleterious consequences could be realized should they leak or break.

Thus, it would be desirable to provide an illuminated container that is portable (i.e., stays lit when moved) and can be attached to or integrated with a variety of containers, including those holding an individual serving of a drinkable liquid, and that keeps the illumination source separate from the contents of the container to avoid accidental contamination or consumption should the illumination source leak, break, or become loose inside the container.

### SUMMARY OF THE INVENTION

The invention relates in general to a container having a convex recess extending into the interior of the container and an illumination source disposed within the convex recess. In one aspect of the invention, a bottle housing a drinkable liquid and having a convex recess has an illumination source disposed within the convex recess for the purpose of emitting light for aesthetic reasons, marketing, and the like.

In another aspect of the invention, the convex recess of the container is formed within the container wall and has a first convex portion and a second convex portion. The second convex portion in this embodiment houses an illumination source, while the first convex portion is adapted to hold a plug or similar device for keeping the illumination source in place.

In yet another aspect of the invention, a bottle containing a drinkable liquid has a convex recess disposed upon the bottom of the bottle and extending upwardly into the bottle interior. An illumination source, such as a light emitting diode (LED), incandescent bulb (e.g., similar to a small “holiday” light bulb), or a chemical illumination source, is disposed within the convex recess.

Various other purposes and advantages of the invention will become clear from its description in the specification that follows. Therefore, to the accomplishment of the objectives described above, this invention includes the features hereinafter fully described in the detailed description of the preferred embodiments, and particularly pointed out in the claims. However, such description discloses only some of the various ways in which the invention may be practiced.

### BRIEF DESCRIPTION OF THE DRAWINGS

FIG. 1 depicts a perspective view of a container of the invention, with a partial cut-away view revealing the illumination source.

FIG. 2 shows a front elevational view of a second embodiment of the invention.

FIG. 3A depicts in perspective view a third embodiment of the invention.

FIG. 3B shows the same embodiment as FIG. 3A from a bottom elevational view.

FIG. 4 illustrates in slightly enlarged, partial cross-section of the embodiment shown in FIG. 3B as taken along line 4-4.

FIG. 5 depicts another embodiment of the inventions in front elevational view.

### DETAILED DESCRIPTION OF THE PREFERRED EMBODIMENTS

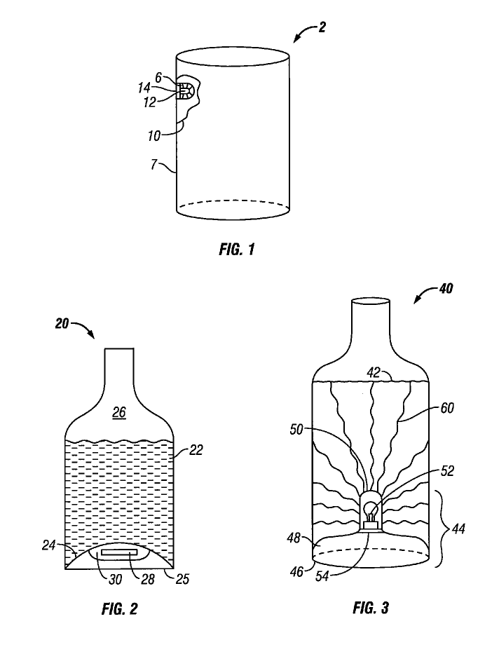

Turning to FIG. 1, the invention generally relates to a container 2 having a convex recess 6 formed into sidewall 7 extending into the interior 8 of the container 2 as seen through cut-away section 10. An illumination source, in this case an LED 12, is disposed within convex recess 6. In this embodiment, a sticker 14 adhered to the outside of the container covers the LED 12 and holds it in place inside the recess 6. Thus, the LED 12 (or other light source) is easily removable for disposal separately from the container 2, which, in most instances, is recycled.

As seen in FIG. 2, a second embodiment of the invention features a transparent bottle 20 housing a drinkable liquid 22, which is an alcoholic beverage in this case. In this embodiment, the bottle 20 contains a convex recess 24 located at the bottom 25 and extending upwardly into the interior 26. Disposed within the recess 24 is an illumination source 28. In this case the illumination source 28 is chemically luminescent and is attached to the upper surface of the convex recess 24 with a hard-setting polymer glue 30, making the attachment of the illumination source 28 more or less permanent.

Turning to FIGS. 3A and 3B, a third embodiment of the invention is illustrated. In this embodiment, a bottle 40 housing a drinkable liquid 42 has a convex recess 44 disposed at the bottom 46 of the bottle 40. The convex recess 44 includes a first convex portion 48 and a second convex portion 50 further extending upwardly from the first convex portion 48.

The illumination source, which is in this case an incandescent bulb 52, is disposed within the second convex portion 50 and secured in place by a threaded plug 54. While the illumination source in this embodiment is depicted to be a simple single incandescent bulb, it should be understood that the invention is not limited to only steady illumination or a particular color. Indeed, a variety of light sources and effects can be achieved, such as “twinkling,” a strobe effect, and alternating changes in color depending on the type and number of light sources used.

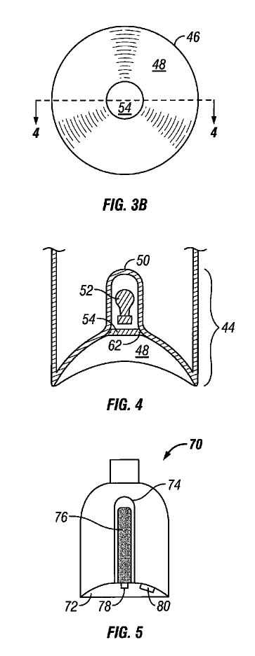

As seen in FIG. 4, the third embodiment of the invention is partially shown in a cross-sectional view taken from roughly the center of the apparatus and viewed downwardly as indicated by arrows at line 4-4. The second convex portion 50 of convex recess 44 preferably is between 0.25 and 1 inch in diameter. This configuration is thought by the inventor to ideally display the light effects 60 (as indicated in FIG. 3A) by housing the illumination source 52 centrally and symmetrically within the bottle 40. Also, threaded plug 54 is shown more clearly to be secured in place through threaded engagement with grooves 62 within second convex portion 50. The recessed portion(s) of all embodiments defines a cavity that in not in contact with any contents of the container, thereby keeping all light sources safely separated from any contents that might be consumed.

FIG. 5 illustrates an embodiment of the invention that is especially useful with cylindrically shaped chemical luminescence products (such as those sold under the name GLOWSTICKS). Container 70 includes a first recessed portion 72 and a second recessed portion 74 into which a luminescence product 76 is held in place by plug 78. The plug 78 may either be part of the luminescence product or separate. Thus, the luminescence product is removeable for separate disposal or for replacement. Alternatively, a second luminescence product 80 may be disposed in the first recessed portion 72 of the container 70 such that both recessed portions house a source of light.

Various changes in the details and components that have been described may be made by those skilled in the art within the principles and scope of the invention herein described in the specification and defined in the appended claims. Therefore, while the present invention has been shown and described herein in what is believed to be the most practical and preferred embodiments, it is recognized that departures can be made therefrom within the scope of the invention, which is not to be limited to the details disclosed herein but is to be accorded the full scope of the claims so as to embrace any and all equivalent processes and products.

What is claimed is:

1. An apparatus, comprising;
a container having a convex recess extending into an interior thereof; and
an illumination source disposed within said convex recess.

2. The apparatus of claim 1, wherein said convex recess includes a first convex portion and a second convex portion further extending from said first convex portion.

3. The apparatus of claim 2, wherein said illumination source is disposed within said second convex portion.

4. The apparatus of claim 2, wherein said illumination source is disposed within said first and said second convex portion.

5. The apparatus of claim 1, wherein said convex recess is located on a bottom of said container and extends upwardly therefrom.

6. The apparatus of claim 2, wherein said first and said second convex portions are located on a bottom of said container and extend upwardly therefrom.

7. The apparatus of claim 3, wherein said first and said second convex portions are located on a bottom of said container and extend upwardly therefrom.

8. The apparatus of claim 1, wherein said illumination source is selected from the group consisting of incandescent, LED, and chemical illumination sources.

9. The apparatus of claim 1, wherein said convex recess is between 0.25 and 1 inch in diameter.

10. The apparatus of claim 2, wherein said second convex portion is between 0.25 and 1 inch in diameter.

11. The apparatus of claim 3, wherein said second convex portion is between 0.25 and 1 inch in diameter.

12. The apparatus of claim 1, wherein said illumination source is permanently sealed within said convex recess.

13. An apparatus, comprising:
a bottle housing a drinkable liquid, said bottle having a convex recess extending into an interior thereof; and
an illumination source disposed within said convex recess.

14. The apparatus of claim 13, wherein said convex recess includes a first convex portion and a second convex portion further extending from said first convex portion.

15. The apparatus of claim 14, wherein said illumination source is disposed within said second convex portion.

16. The apparatus of claim 14, wherein said illumination source is disposed within said first and said second convex portion.

17. The apparatus of claim 13, wherein said convex recess is located on a bottom of said bottle and extends upwardly therefrom.

18. The apparatus of claim 14, wherein said first and said second convex portions are located on a bottom of said bottle and extend upwardly therefrom.

19. The apparatus of claim 15, wherein said first and said second convex portions are located on a bottom of said bottle and extend upwardly therefrom.

20. The apparatus of claim 13, wherein said illumination source is selected from the group consisting of incandescent, LED, and chemical illumination sources.

21. The apparatus of claim 13, wherein said convex recess is between 0.25 and 1 inch in diameter.

22. The apparatus of claim 14, wherein said second convex portion is between 0.25 and 1 inch in diameter.

23. The apparatus of claim 15, wherein said second convex portion is between 0.25 and 1 inch in diameter.

24. The apparatus of claim 13, wherein said illumination source is permanently sealed within said convex recess.

25. The apparatus of claim 13, wherein said illumination source is removable.
